(19) United States
(12) Patent Application Publication
(10) Pub. No.: US 2023/0316145 A1
(43) Pub. Date: Oct. 5, 2023

(54) SYSTEMS AND METHODS FOR KNOWLEDGE EXTRACTION

(71) Applicant: Xformics Inc., North Andover, MA (US)

(72) Inventors: Radhakrishnan POOMARI, Markham (CA); Mahesh GOPALAN, Leander, TX (US)

(73) Assignee: Xformics Inc., North Andover, MA (US)

(21) Appl. No.: 18/189,872

(22) Filed: Mar. 24, 2023

Related U.S. Application Data
(60) Provisional application No. 63/362,092, filed on Mar. 29, 2022.

(51) Int. Cl. G06N 20/00

(52) U.S. Cl. CPC G06N 20/00

(57) ABSTRACT

A computer-implemented method for providing informative output from extracted features of a raw dataset is disclosed. The computer-implemented method includes: receiving, at an application platform associated with a computer system, an upload of the raw dataset; identifying, using a processor associated with the computer system, a trained machine-learning model configured to process data that shares a context associated with the raw dataset; applying, using the processor, the raw dataset to the trained machine-learning model; receiving, from the trained machine-learning model, an output result; and presenting, subsequent to the receiving, the output result on the application platform. Other aspects are described and claimed.

### CROSS REFERENCE TO RELATED APPLICATIONS

This application claims priority to U.S. application Ser. No. 63/362,092, filed on Mar. 29, 2022, which is incorporated by reference herein in its entirety.

### TECHNICAL FIELD

Various embodiments of this disclosure relate generally to machine-learning based techniques for automatically extracting knowledge from unstructured data. In some embodiments, the disclosure relates to systems and methods for analyzing a dataset and extracting various types of insights and/or solutions from the raw data.

### BACKGROUND

Many entities (e.g., companies, businesses, organizations, etc.) generate a large amount of raw data during their normal course of operation. For example, with respect to a customer service division of an organization, various aspects associated with a customer call may be gleaned (e.g., the identity of the customer, the identity of the customer service representative, the subject of the call, the length of the call, the ultimate result of the call, and the like). Although this type of raw data is generally recorded and stored, actionable insights are rarely gathered and subsequently leveraged to improve overall workflow. Moreover, the volume and/or complexity of such raw data may make determining such insights difficult, complex, and/or costly. This disclosure is directed to addressing one or more of the above-referenced challenges.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for analyzing raw datasets and performing one or more downstream functions based on this analysis.

In one aspect, a computer-implemented method for providing informative output from extracted features of a raw dataset is provided. The computer-implemented method includes: receiving, at an application platform associated with a computer system, an upload of the raw dataset; identifying, using a processor associated with the computer system, a trained machine-learning model configured to process data that shares a context associated with the raw dataset; applying, using the processor, the raw dataset to the trained machine-learning model; receiving, from the trained machine-learning model, an output result; and presenting, subsequent to the receiving, the output result on the application platform.

In another aspect, a system for providing informative output from extracted features of a raw dataset is provided. The system includes: at least one database; a processor; a server in network communication with the at least one database; the server configured to perform operations including: receiving, at an application platform associated with the computer system, an upload of the raw dataset; identifying, using the processor, a trained machine-learning model configured to process data that shares a context associated with the raw dataset; applying, using the processor, the raw dataset to the trained machine-learning model; receiving, from the trained machine-learning model, an output result; and presenting, subsequent to the receiving, the output result on the application platform.

In yet another aspect, a non-transitory computer-readable medium is provided. The non-transitory computer-readable medium stores computer-executable instructions which, when executed by a server in network communication with at least one database, cause the server to perform operations that may include: receiving, at an application platform associated with a computer system, an upload of the raw dataset; identifying, using a processor associated with the computer system, a trained machine-learning model configured to process data that shares a context associated with the raw dataset; applying, using the processor, the raw dataset to the trained machine-learning model; receiving, from the trained machine-learning model, an output result; and presenting, subsequent to the receiving, the output result on the application platform.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims

### BRIEF DESCRIPTION OF THE DRAWINGS

The accompanying drawings, which are incorporated in and constitute a part of this specification, illustrate various exemplary embodiments, and together with the description, serve to explain the principles of the disclosed embodiments.

FIG. 1 depicts an exemplary environment for training and/or utilizing a machine-learning model to automatically extract information from a raw dataset, according to one or more embodiments.

FIG. 2 depicts a flowchart of an exemplary method of utilizing a machine-learning model to extract information from a raw dataset, according to one or more embodiments.

FIG. 3 depicts a cluster graph generated from an exemplary dataset, according to one or more embodiments.

FIG. 4 depicts cluster graphs from an exemplary dataset, according to one or more embodiments.

FIG. 5 depicts a network graph generated from an exemplary dataset, according to one or more embodiments.

FIG. 6 depicts a choropleth graph generated from an exemplary dataset, according to one or more embodiments.

FIG. 7 depicts a time series plot generated from an exemplary dataset, according to one or more embodiments.

FIG. 8 depicts a cluster graph generated from an exemplary dataset, according to one or more embodiments.

FIG. 9 depicts a horizontal bar graph generated from an exemplary dataset, according to one or more embodiments.

FIG. 10 depicts a cluster graph generated from an exemplary dataset, according to one or more embodiments.

FIG. 11 depicts an alternate presentation of the cluster graph in FIG. 10, according to one or more embodiments.

FIG. 12 depicts a ratings graph generated from an exemplary dataset, according to one or more embodiments.

FIG. 13 depicts a plot graph generated from an exemplary dataset, according to one or more embodiments.

FIG. 14 depicts a cluster graph generated from an exemplary dataset, according to one or more embodiments.

FIG. 15 depicts another view of the cluster graph depicted in FIG. 14, according to one or more embodiments.

FIG. 16 depicts another view of the cluster graph depicted in FIGS. 14-15, according to one or more embodiments.

FIG. 17 depicts an exemplary flowchart of a computer-implemented method for providing informative output from extracted features of a raw dataset, according to one or more embodiments.

### DETAILED DESCRIPTION OF EMBODIMENTS

According to certain aspects of the disclosure, methods and systems are disclosed for automatically extracting knowledge from a raw dataset and thereafter utilizing that information to perform one or more downstream functions (e.g., identify associations between data points, generate graphical reports illustrating trends and/or relationships, provide dynamic suggestions, etc.).

As entities grow, the data generated from their daily workflow increases, sometimes exponentially so. This data may contain valuable information that may help an entity improve their efficiency, product quality, resource allocation, and/or a variety of other aspects associated with their business. However, such data is rarely analyzed to glean these informative insights. When it is, the analysis is conventionally conducted at a macro level and may not be granular enough to reveal subtle relationships between data points. Additionally, extracting knowledge from unstructured datasets may be challenging. This challenge may be further compounded when the dataset is not of a conventional format (e.g., a document having labeled fields, a designated structure, consistent language usage, etc.). Furthermore, the output generated by conventional data analysis techniques is generic and is not tailored to the specific context associated with the data and/or data producer. Accordingly, improvements in technology relating to information extraction from raw datasets are needed.

As will be discussed in more detail below, the present disclosure provides a system for automatically extracting knowledge such as non-intuitive insights and actionable information from a raw and unstructured dataset. More particularly, by training a machine-learning model, e.g., via supervised or semi-supervised learning, to learn associations between raw data and context-specific metrics associated with a particular organization (e.g., organization type, structure, goals, activities, etc.), the trained machine-learning model may be usable to automatically extract and analyze various types of information from a dataset and provide context-specific insights and/or suggestions as a result of the analysis. Additionally, the present disclosure provides an application platform (e.g., resident on a user device) that may enable users to upload a dataset to be analyzed, select a specific machine-learning model based upon the context of their dataset (or have a specific machine-learning model dynamically assigned based on an analysis of the dataset), provide additional contextual designations regarding their dataset to the selected machine-learning model, adjust aspects of machine-learning model templates to improve analysis, etc., and may ultimately provide users with one or more output features based on the analysis.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “about,” and “generally,” are used to indicate a possible variation of ±10% of a stated or understood value.

As used herein, the term “user” generally encompasses any person or entity that may desire information, resolution of an issue, or engage in any other type of interaction with a provider of the systems and methods described herein (e.g., via an application interface resident on their electronic device, etc.). The term “browser extension” may be used interchangeably with other terms like “program,” “electronic application,” or the like, and generally encompasses software that is configured to interact with, modify, override, supplement, or operate in conjunction with other software.

As used herein, a “machine-learning model” or “knowledge discovery platform” generally encompasses instructions, data, and/or a model configured to receive input, and apply one or more of a weight, bias, classification, or analysis on the input to generate an output. The output may include, for example, an analysis based on the input, a prediction, suggestion, or recommendation associated with the input, a dynamic action performed by a system, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as k-nearest neighbors, linear regression, logistical regression, random forest, gradient boosted machine (GBM), support-vector machine, deep learning, a deep neural network, and/or any other suitable machine-learning technique that solves problems in the field of Natural Language Processing (NLP). Supervised, semi-supervised, and/or unsupervised training may be employed. For example, supervised learning may include providing training data and labels corresponding to the training data, e.g., as ground truth. Unsupervised approaches may include clustering, classification, or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a machine-learning model may be trained to glean information from patient drug review data. This data may be derived, for example, from reviews provided by individuals who have previously consumed a particular drug in order to alleviate or eliminate the effects of a disease or condition. Ultimately, after being processed and analyzed as further described herein, the machine-learning model may provide one or more output features that may enable entities to: better understand the overall satisfaction levels of patients after they have consumed prescribed drugs, identify side-effects that are most commonly associated with negatively labelled drugs, and/or help manufacturers take notice and improve the efficacy of these drugs.

In another exemplary use case, a machine-learning model may be trained to glean information from customer service data. This data may be derived, for example, from customer queries directed toward a customer service division of an organization. Ultimately, after being processed and analyzed as further described herein, the machine-learning model may provide one or more output features that may enable entities to obtain insights into: the volume of customer queries, the subject or topic of the majority of those queries, seasonal and event-specific query trends, the success rate at which those queries are resolved, and other metrics associated with query receipt and resolution.

In another exemplary use case, a machine-learning model may be trained to glean information from industrial work orders. This data may be derived, for example, from past work orders generated by an entity. Ultimately, after being processed and analyzed as further described herein, the machine-learning model may provide one or more output features that may enable entities to obtain insights into: the frequency with which work orders are generated for each entity location and/or associated facility, the lifespan of assets that are the subject of the work orders, the resources involved in the work order to repair an asset, and other metrics associated with work order creation and resolution implementation.

In another exemplary use case, the machine-learning model may be accessible to one or more users (e.g., paid subscribers) via an application platform resident on their user device(s). The application platform may enable users to upload a dataset that they would like analyzed and may additionally contain options for users to provide contextual designations to the dataset prior to processing. For instance, users may select a specific machine-learning model that is associated with the context of their dataset. More particularly, a system may contain a plurality of machine-learning models, each of which may be associated with a different field or industry (i.e., each industry-specific machine-learning model may be primed on aspects of the industry it is associated with). A user may thereafter choose the machine-learning model that is most closely associated with the nature of their dataset. For example, a user interested in having a dataset of patient drug reviews analyzed may select (e.g., from a drop-down list of available machine-learning models) a machine-learning model trained on aspects of the pharmaceutical industry. Alternatively to the foregoing, the application platform may analyze the dataset to derive a context associated with it (e.g., which field or industry the data in the dataset is associated with) and may thereafter select a machine-learning model that is best trained to handle the context of the dataset.

Subsequent to selection of a specific machine-learning model, a user may be provided with a template associated with their chosen model that optionally enables them to define additional, industry-specific parameters associated with their dataset (e.g., the geographic location(s) where the dataset was derived, the people and/or objects that are the subjects of the dataset, the nature of the work performed that generated the dataset, etc.). These designations may enable a machine-learning model to more accurately process the dataset based on the additional context. Furthermore, users may be able to interact with and/or adjust the provided templates (e.g., to add, remove, emphasize, de-emphasize, etc., various aspects of the dataset) in order to increase the likelihood that selected machine-learning model generates more relevant output features.

It is important to note that the examples listed above are non-limiting. More particularly, the techniques described herein may be adapted to virtually any type of dataset from which information may be extracted. It should also be understood that the examples above are illustrative only. Accordingly, the techniques and technologies of this disclosure may be adapted to any suitable activity.

Presented below are various aspects of machine-learning techniques that may be adapted to automatically extract information from a raw dataset. As will be discussed in more detail below, machine-learning techniques adapted to extract insight information from a raw and unstructured dataset and thereafter provide contextual insight based on the analysis of the unstructured dataset may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

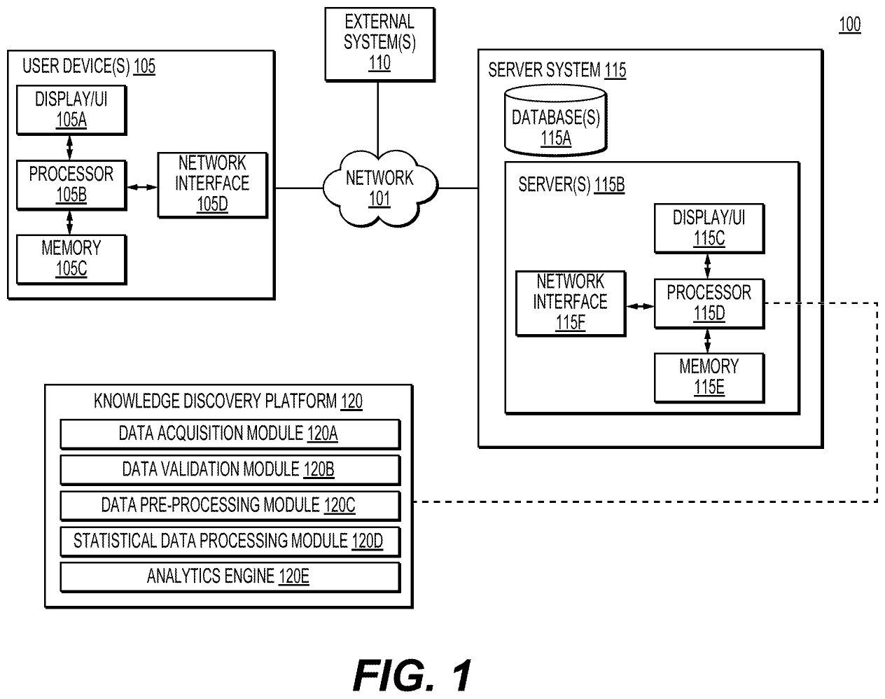

FIG. 1 depicts an exemplary environment 100 that may be utilized with the techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more user device(s) 105 may be associated with a user, e.g., a user associated with one or more of generating, training, or tuning a machine-learning model for extracting knowledge from a document, generating, obtaining, and/or analyzing document data. For example, the one or more user device(s) 105 may be associated with a company officer, strategist, or other company representative seeking to gain the insights and/or benefits derived from the capabilities of the server system(s) 115.

In some embodiments, the components of the environment 100 may be associated with a common entity, e.g., a single business or organization, or, alternatively, one or more of the components may be associated with a different entity than another. The systems and devices of the environment 100 may communicate in any arrangement. For example, one or more user device(s) 105 may be associated with one or more clients or service subscribers, and server system 115 may be associated with a service provider responsible for receiving raw datasets from the one or more clients or service subscribers. As will be discussed herein, systems and/or devices of the environment 100 may communicate in order to generate, train, and/or use a machine-learning model to extract information from a raw and unstructured dataset, among other activities.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include a display/user interface (UI) 105A, a processor 1058, a memory 105C, and/or a network interface 105D. The user device 105 may execute, by the processor 1058, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the 0/S. The network interface 105D may be a TCP/IP network interface for, e.g., Ethernet or wireless communications with the network 101. The processor 1058, while executing the application, may generate data and/or receive user inputs from the display/UI 105A and/or receive/transmit messages to the server system 115, and may further perform one or more operations prior to providing an output to the network 101.

The electronic application, executed by the processor 1058 of the user device 105, may generate one or many points of data that can be applied via an overall system, such as for a document extraction platform. As an example, the user device 105 may be, e.g., a client computing device that may receive, at an application platform resident on the client computing device, the raw and unstructured dataset.

External systems 110 may be, for example, one or more third party and/or auxiliary systems that integrate and/or communicate with the server system 115 in performing various information extraction tasks. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, computer-readable memory such as a hard drive, flash drive, disk, etc. In some embodiments, the server system 115 includes and/or interacts with an application programming interface for exchanging data to other systems, e.g., one or more of the other components of the environment. The server system 115 may include and/or act as a repository or source for extracted raw dataset information.

The server system 115 may include a database 115A and at least one server 1158. The server system 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 1158 to control the functions of the server 1158. The server system 115 may execute, by the processor 115D, an operating system (O/S) and at least one instance of a servlet program (each stored in memory 115E). When user device 105 sends a raw dataset to the server system, the received dataset and/or dataset information may be stored in memory 115E or database 115A. The network interface 115F may be a TCP/IP network interface for, e.g., Ethernet or wireless communications with the network 101.

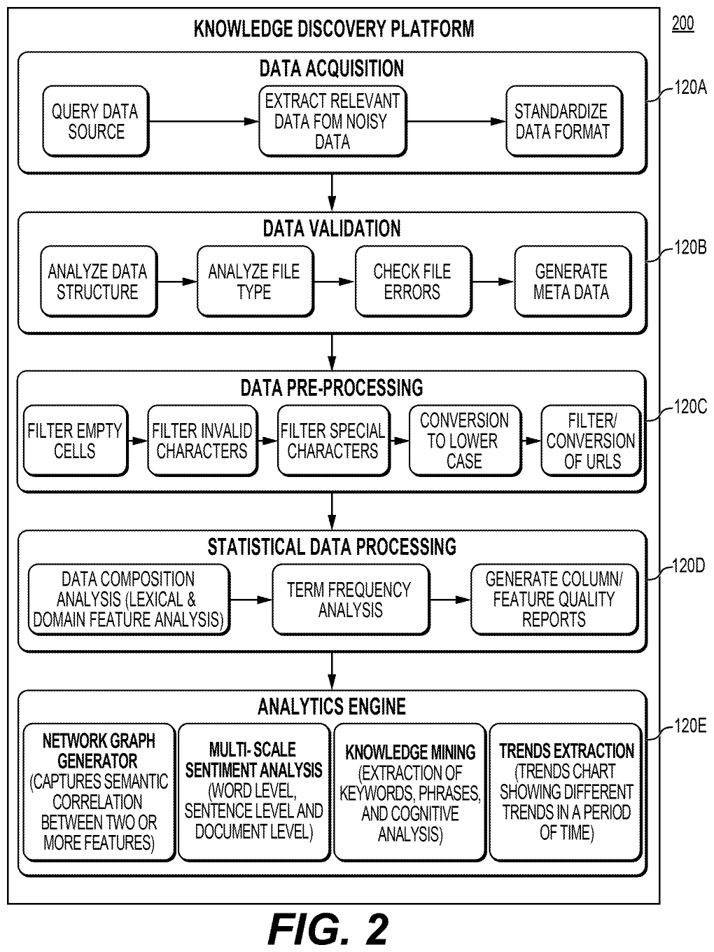

The processor 115D may include and/or execute instructions to implement a knowledge discovery platform 120, as concurrently illustrated in FIG. 2, which may include a data acquisition module 120A, a data validation module 1208, a data pre-processing module 120C, a statistical data processing module 120D, and/or an analytics engine 120E. The knowledge discovery platform 120 may include instructions for automatically extracting knowledge from a raw dataset. The data acquisition module 120A may include instructions for querying a data source, extracting relevant data from raw/noisy data in the data source, and placing that extracted data into a standardized data format. The data validation module 1208 may include instructions for analyzing data structure and file type, checking file errors, and generating metadata. The data pre-processing module 120C may include instructions for preprocessing a dataset (e.g., filtering textual aspects associated with the dataset and implementing textual conversions, etc.). The statistical data processing module 120D may include instructions for performing data composition and term frequency analysis and generating one or more column/feature quality reports. The analytics engine 120E may include instructions for generating one or more visual graphs (i.e., that capture semantic correlations between two or more features of the dataset), performing multi-scale sentiment analysis (e.g., world level, sentence level, document level, etc.), performing knowledge mining (e.g., extraction of key words, phrases, and/or cognitive analysis), and implementing trends extraction.

In an embodiment, the data acquisition module 120A, the data validation module 1208, the data pre-processing module 120C, the statistical data processing module 120D, and the analytics engine 120E may all be contained within the knowledge discovery platform 120. Alternatively, some or all of such modules may be submodules of other modules within each other or may be resident on other components of the environment 100. For example, the data acquisition module 120A, may be incorporated into an application platform on the user device 105 whereas the data validation module 1208, the data pre-processing module 120C, the statistical data processing module 120D, and analytics engine 120E may be contained within the knowledge discovery platform 120.

As discussed in further detail below, the server system 115 may generate, store, train, or use one or more machine-learning models configured to extract knowledge from raw and unstructured data and provide one or more output features based on that analysis. The server system 115 may include one or more machine-learning models and/or instructions associated with each of the one or more machine-learning models, e.g., instructions for generating a machine-learning model, training the machine-learning model, using the machine-learning model, etc. The server system 115 may include instructions for retrieving output features, e.g., based on the output of the machine-learning model, and/or operating the displays 105A and/or 115C to generate one or more output features, e.g., as adjusted based on the machine-learning model.

The server system 115 may include one or more sets of training data. The training data may contain data of various conventional and/or non-conventional formats (e.g., a set of documents, a series of consumer reviews, a transcription of a recorded conversation, a work order transcript or invoice, etc.) and each set, or cluster, of training data may be associated with a particular context (e.g., a particular industrial field, a particular activity, a particular purpose, etc.).

In some embodiments, a system or device other than the server system 115 may be used to generate and/or train the machine-learning model. For example, such a system may include instructions for generating the machine-learning model, the training data and ground truth, and/or instructions for training the machine-learning model. A resulting trained machine-learning model may then be provided to the server system 115.

In some embodiments, a machine-learning model based on neural networks includes a set of variables, e.g., nodes, neurons, filters, etc., that are tuned, e.g., weighted or biased, to different values via the application of training data. In other embodiments, a machine learning model may be based on architectures such as support-vector machines, decision trees, random forests or Gradient Boosting Machines (GBMs). Alternate embodiments include using techniques such as transfer learning, wherein one or more pre-trained machine learning models on large common or domain specific dataset may be leveraged for analyzing the training data.

In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn semantic associations between the raw data and the context with which it is associated with (e.g., aspects of the industrial or professional field that the raw data is associated with, etc.), such that the trained machine-learning model is configured to provide output features that are contextually relevant for a user's purpose.

In various embodiments, the variables of a machine-learning model may be interrelated in any suitable arrangement in order to generate the output. For example, in some embodiments, the machine-learning model may include signal processing architecture that is configured to identify, isolate, and/or extract features, patterns, and/or structure in a text. For example, the machine-learning model may include one or more convolutional neural network (“CNN”) configured to identify features in the document information data, and may include further architecture, e.g., a connected layer, neural network, etc., configured to determine a relationship between the identified features in order to determine a location in the document information data. Furthermore, in other embodiments, processor 1058, processor 115D, and/or data acquisition module 120A may include known optical character recognition (OCR) techniques that transform an incoming document image, such as a scanned or faxed document, into a text that is suitable as input for data validation module 1208.

For example, in some embodiments, the machine-learning model of the server system 115 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of letters or words as input, and generate a sequence of locations, e.g., a path of relevant text passages in the report as output.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

In the following methods, various acts may be described as performed or executed by a component from FIG. 1, such as the server system 115, the user device 105, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

Provided below are a plurality of exemplary use cases in which the aforementioned machine-learning systems and methods may be leveraged. It is important to note that these use cases are non-limiting and that the concepts described herein may be leveraged to extract useful and actionable information from raw and/or unstructured datasets associated with a variety of different contexts and situations.

In each of the subsequent use cases, a raw and unstructured dataset may be uploaded to the server 115 via an application platform resident on a user device 105. In some embodiments, the dataset may reside in one or more legacy databases of a company or organization that can be accessed by the server 115 through appropriate permissions and/or intermediary applications. The application platform may contain a user interface that enables a user to select a dataset to upload to the application platform (e.g., via selection of a “Browse” icon and subsequent selection of a data file stored in an accessible database in the memory 105C). Once selected, the user may choose to simply transmit the uploaded file to the server system 115 for processing (e.g., via selection of an “Upload” icon”). Alternatively, the application platform may enable the user to provide additional context to the dataset that may aid the knowledge discovery platform 120 in generating more accurate and tailored output features. For example, the user may be able to designate one or more of: the nature/composition of content contained in the dataset (e.g., customer reviews, transcribed text of recorded calls, work order documents, etc.), an industrial field or profession that the dataset is associated with (e.g., medicine, construction, finance, etc.), an activity in which the dataset is used (e.g., a clinical trial, a maintenance process, a business proceeding, etc.), and the like.

In a first use case, a dataset comprised of customer queries may be received, e.g., at a data acquisition module 120A. The customer queries may correspond to questions that an individual may have related to a particular product or service offered by an entity. For example, with respect to a bank, potential queries may include “what are the documents required for opening a current account”, “what are included in bulk transactions”, “can I transfer my current account from one branch to another”, and the like. In an embodiment, these queries may be manifest as raw, transcribed text data from a phone conversation between a consumer and a customer support representative. In an embodiment, after elementary data cleaning is performed (e.g., via data validation module 1208 and/or data pre-processing module 120C), a restructured dataset may be obtained that contains textual and/or numerical data for each query that identifies: the query itself, the answer to the query, the category or context associated with the query, the city in which the query originated and/or pertained to, the identity of the employee assigned to resolve the query, the date of query resolution, a consumer rating associated with the query resolution process, keywords in the query or resolution, and/or other metrics not explicitly listed or described herein.

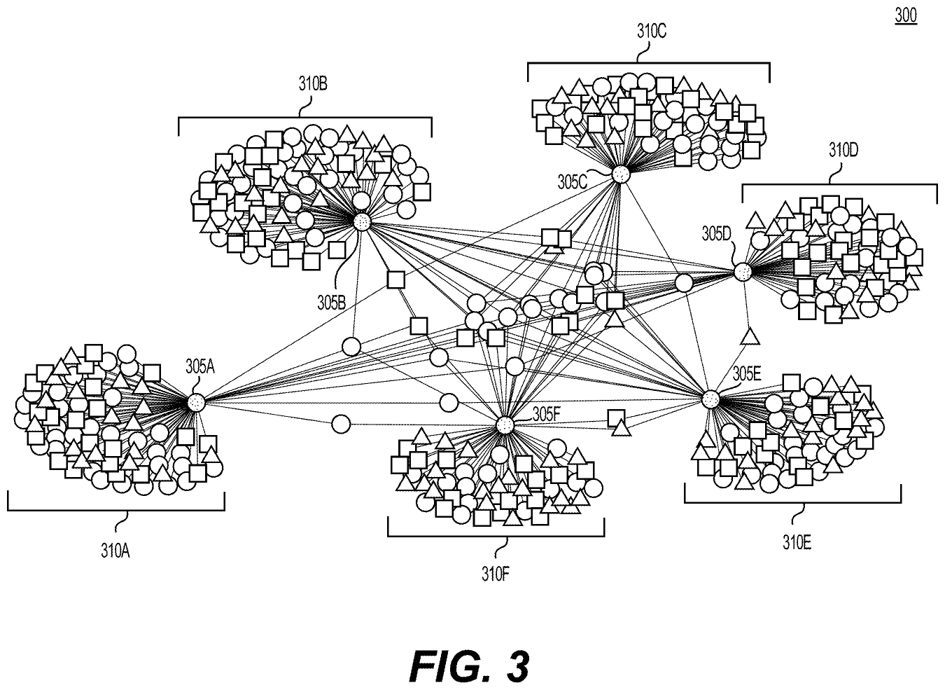

Upon further processing, e.g., conducted by statistical data processing module 120D and/or analytics engine 120E, one or more output features may be provided to the user. For example, the server system 115 may transmit instructions to the user device to provide (e.g., on the display 105A) one or more semantic graphs that may identify relationships between data points in the dataset. For instance, turning now to FIG. 3, a network graph 300 is illustrated that shows the employees involved in the resolution of a particular query. Each employee may be represented by a parent node 305 (A-F) and the cluster of leaf nodes 310 (A-F) stemming from each parent node 305 (A-F) may represent the volume of queries handled by each employee. In real use, the color of each individual node within each cluster of leaf nodes 310 (A-F) may represent how satisfied a consumer was with the solution provided by their customer service representative (e.g., green may indicate that the customer was very satisfied, grey may indicate that the customer was somewhat satisfied, and red may indicate that the customer was not satisfied at all). For purposes of this application, the parent node 305 (A-F) that is representative of each employee may be presented as a filled circle (e.g., containing dots), a satisfied query may be presented as an empty circle, a somewhat satisfied query may be presented as a square, and a dissatisfied query may be presented as a triangle. An administrator viewing this graph may quickly glean various types of insightful information such as: which employee has entertained the largest volume of calls, which employee is the most successful at handling customer queries, which employee is the most in need of help, and the like. For example, FIG. 3 illustrates that employee 305B disposed of a greater number of queries and had a higher proportion of satisfied query dispositions than employee 305F. Additionally or alternatively, the server system 115 may, in conjunction with or in lieu of providing a user with this network graph 300, provide the user with one or more dynamic suggestions. For example, the server system 115 may dynamically suggest that a successful employee (i.e., one who has disposed of a larger number of customer queries to the customer's satisfaction, such as employee 305B) train or be temporarily grouped with a struggling employee (i.e., one who has a large number of unsatisfied customer reviews, such as employee 305F).

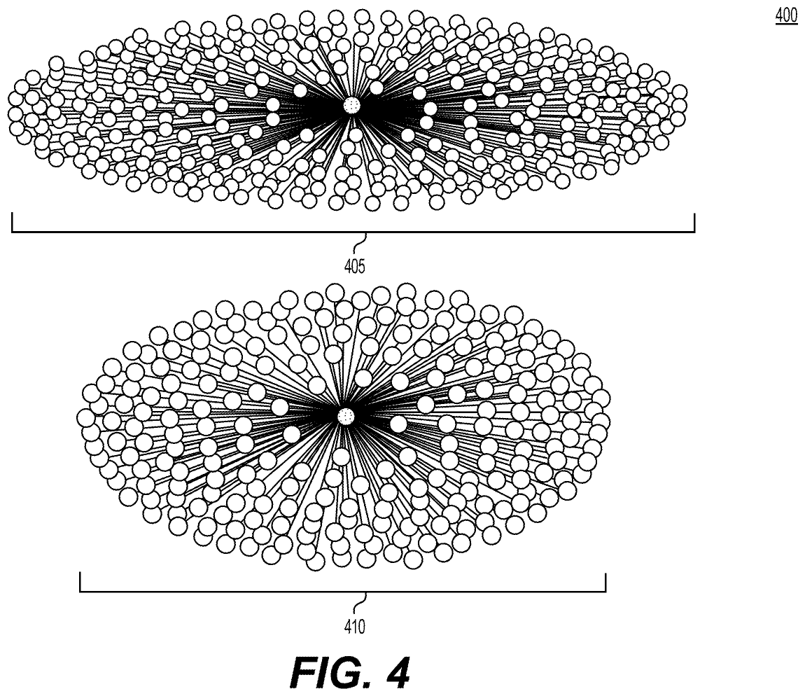

Turning now to FIG. 4, the server system 115 may provide a plurality of cluster graphs 400 that may show the particular categories of a contextual field that the customer queries from FIG. 3 are associated with. For instance, in the example of a bank, cluster 405 illustrates queries directed to an accounts department whereas cluster 410 illustrates queries directed to a cards department. In an embodiment, the central node in each cluster (represented in FIG. 4 as a filled-in circle with dots) may represent the category that each query is related to. The other nodes stemming from the central node (represented in FIG. 4 as empty circles) represent the queries with their solutions. These graphs may allow an administrator to easily identify the aspects of their organization, product, or process that consumers have the most questions about. Additionally or alternatively, the system 115 may dynamically provide suggestions to allocate resources to particular departments that are associated with high-queried topics.

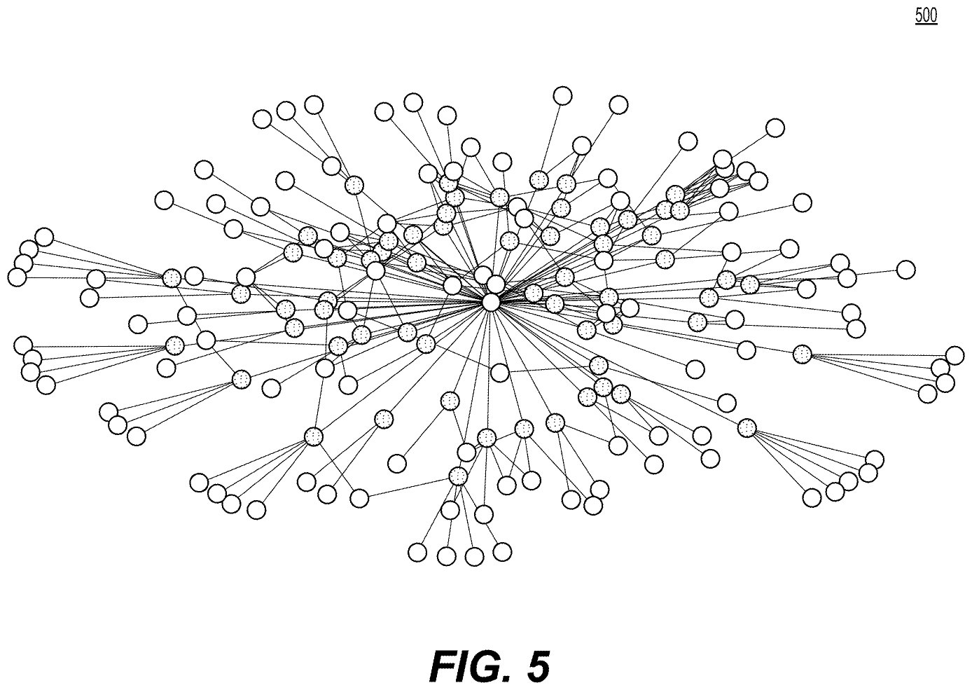

Turning now to FIG. 5, the server system 115 may provide a network graph 500 that may show deeper relationships between the queries from FIG. 3. More particularly, the solid nodes (i.e., those filled with dots) may represent the queries themselves and the empty nodes may represent the common terms identified in each query (e.g., via utilization a natural language processing technique, etc.). For instance, an empty node may correspond to the term “minimum balance required”, which may be a term that is present in three separate queries, e.g., “Minimum balance required for Account Type A?”, “What is the minimum balance required for an Account Type B?”, “Is there a minimum balance required for Account Type C?” Such an empty node may therefore be connected to three solid nodes. Closer examination of FIG. 5 reveals that the empty nodes near the center of the network graph 500 are common terms shared by many queries whereas the empty nodes near the periphery of the network graph 500 are common terms contained primarily in one query.

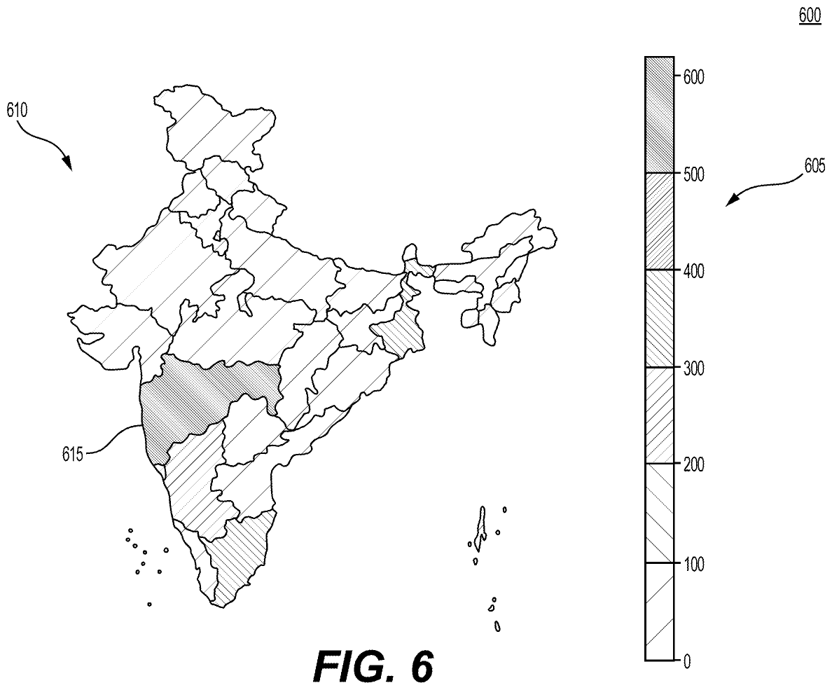

Turning now to FIG. 6, the server system 115 may provide a choropleth map 600 that may show the trend in issues based on the geographic locations from where the queries originated. More particularly, the choropleth map 600 may contain a geographic representation of a location 605 and a scale 610 that provides an indication of the volume of queries originating from each geographic location (e.g., where the darker-shaded regions represent areas with a higher volume of customer queries than the lighter-shaded regions, etc.). This map may be implemented on a variety of different scales (e.g., on a country level, a state level, a city level, a town level, etc.). In an embodiment, the server system 115 may provide suggestions to increase an entity's presence in a certain geographic area and/or to improve an entity's product offering in that geographic area based on the volume of customer queries originating from that area. For instance, given the choropleth map 600 in FIG. 6, the server system 115 may recommend that an entity should allocate additional resources to region 615 in view of the high number of customer queries originating from that region.

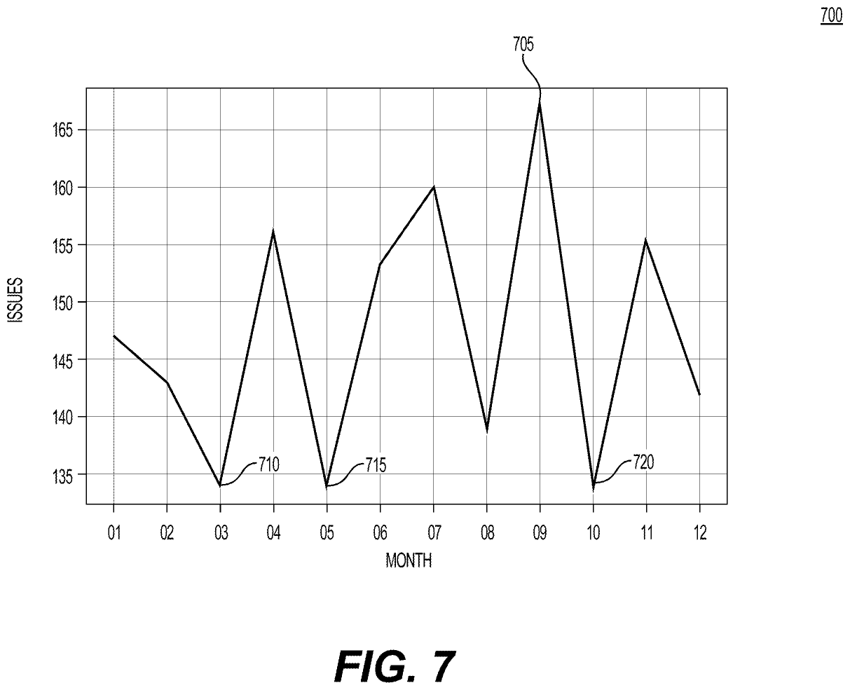

Turning now to FIG. 7, the server system 115 may provide a time series plot 700 that may show the number of complaints and/or queries raised by a customer at different times of the year. Upon examination of the given plot 700, September 705 has the highest number of queries raised whereas March 710, June 715, and October 720 have the least number of queries raised. In an embodiment, the server system 115 may provide a suggestion to a user (e.g., an entity official, etc.) to increase staff assistance and/or product supply during peak periods of the year, such as in September 705, and reduce staff hiring practices and/or reduce product production during off periods of the year, such as in March 710, June 715, and October 720, to conserve costs.

In an embodiment, any number of the foregoing graphs, maps, and/or plots may be utilized in conjunction to obtain more detailed information about a situation. For instance, the choropleth map 600 in FIG. 6 may be utilized in conjunction with the time series plot 700 to identify that region 615 in FIG. 6 receives a large number of customer complaints or queries in September but those complaints or queries decline substantially in March, June and October, as indicated in FIG. 7.

In a second use case, a dataset comprised of patient drug review data may be received, e.g., at a data acquisition module 120A. The patient drug review data may be composed of anonymized private data (e.g., provided by one or more verified patients in response to a targeted survey, etc.) and/or public data (e.g., drug reviews obtained from online forums, review sites, etc.). In an embodiment, after elementary data cleaning is performed (e.g., via data validation module 120B and/or data pre-processing module 120C), a restructured dataset may be obtained that contains textual and/or numerical data for each patient review that identifies: the drug name, the drug ID, the patient's condition for which the drug was taken, the content of the review itself, the rating of the drug, the date the review was provided, a useful count indication, a sentiment identification for the drug (e.g., positive or negative feelings toward the drug, etc.), and/or other metrics not explicitly listed or described herein.

Upon further processing (e.g., natural language processing, etc.), e.g., conducted by statistical data processing module 120D and/or analytics engine 120E, a patient sentiment associated with each patient review may be identified (i.e., whether the patient view toward and/or experience with the drug was positive or negative). For example, target keywords in a patient review such as “saved” and “lifesaver” may direct the server system 115 to assign a positive connotation for a review whereas other keywords such as “toxicity” and “disappointed” may direct the server system 115 to assign a negative connotation for a review. In each dataset, the negative reviews may be of interest as those reviews indicate the issues that individuals have had with a company's product or service. For each set of negative reviews, patient conditions may be identified and potential side effects resulting from a drug taken to treat these conditions may be recorded and compared to known side-effects to identify any discrepancies. For example, given a set of patient reviews for different drugs directed to three conditions, i.e., Alzheimer's disease, Asthma, and Hearth disease, three major outlier side-effects (i.e., those side effects reported by patients but not in the list of expected side-effects) were identified based upon the process above: unresponsiveness (Alzheimer's), loss of taste (Asthma), and weight gain (Asthma).

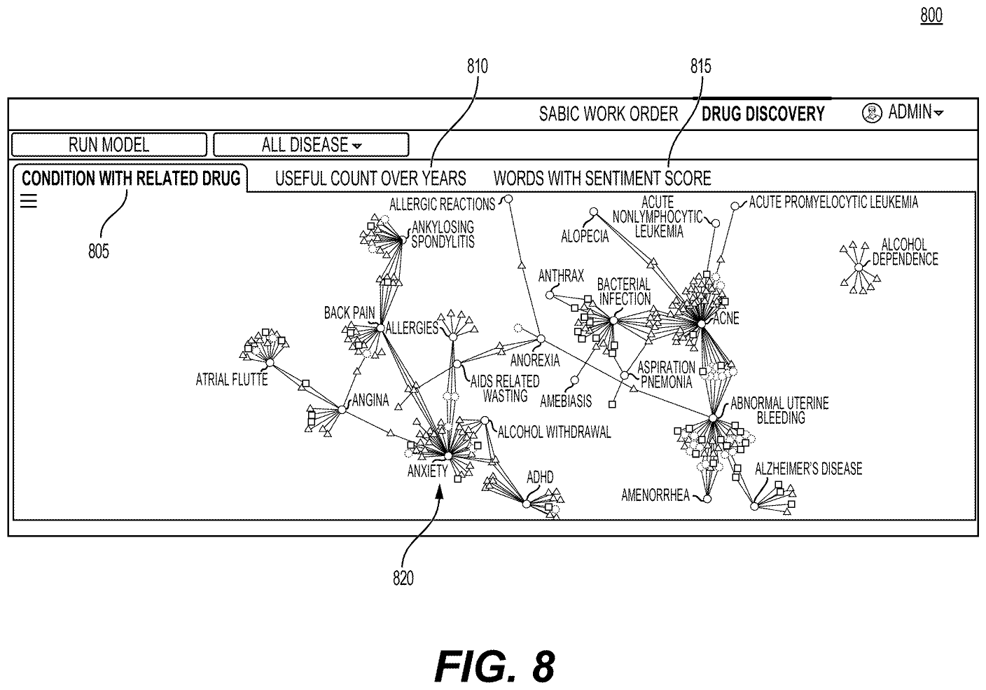

Turning now to FIG. 8, an application platform 800 is provided that may enable a user to obtain indications of relationships between various conditions and the drugs taken by individuals to address those conditions. The application platform may contain analysis options 805, 810, and 815, which may allow individuals to gain insights into the data from different perspectives. For instance, upon selection of analysis option 805, which corresponds to “Condition with Related Drug”, the server system 115 may provide a cluster graph, as depicted in FIG. 8, that provides relationship identifications between a patient's condition and the related drugs that they had taken to treat that condition. A central node in each cluster may represent the condition for which a particular drug was taken (e.g., anxiety, anemia, allergies, back pain, etc.) and each leaf node in the cluster may represent a patient that took the drug for the designated condition. In an embodiment, the information in the cluster graph may be color-coded, or otherwise visually distinguished, so that each leaf node may indicate a positive or negative sentiment of the patient review (e.g., red may indicate a negative sentiment whereas green may indicate a positive sentiment). For purposes of this application, the central node may be represented as a circle, a positive sentiment leaf node may be represented as a triangle, a negative sentiment leaf node may be represented as a square, and an unidentified sentiment leaf node may be represented as a circle with broken lines. For instance, examination of the data subset 820 that corresponds to the condition “anxiety” reveals that many individuals took a particular drug to treat the anxiety condition and the overwhelming sentiment towards that drug was positive.

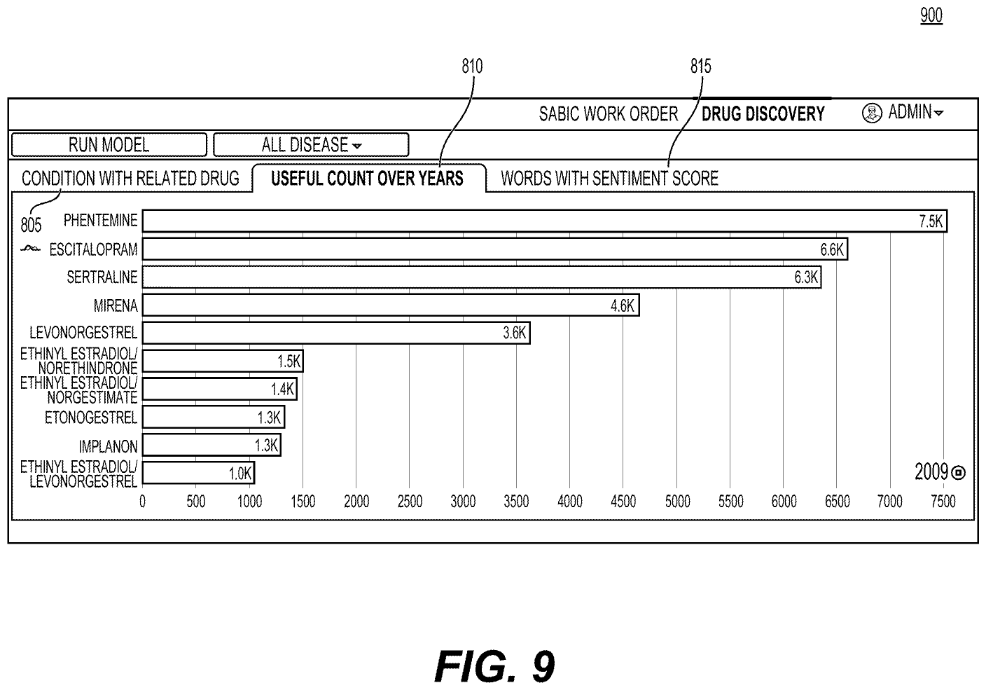

Turning now to FIG. 9, upon selection of another analysis option, such as option 810, the server system 115 may provide a horizontal bar graph indicating popularity trends for different drugs utilized over a designated period of time. Knowledge of these trends may aid an individual or entity in making resource and/or policy decisions (e.g., a drug with a decreasing usage trend may be identified by a company as one not worth producing, etc.). In an embodiment, the server system 115 may make dynamic suggestions found in the horizontal bar graph (e.g., to discontinue production of a particular drug, to increase production of a particular drug, etc.).

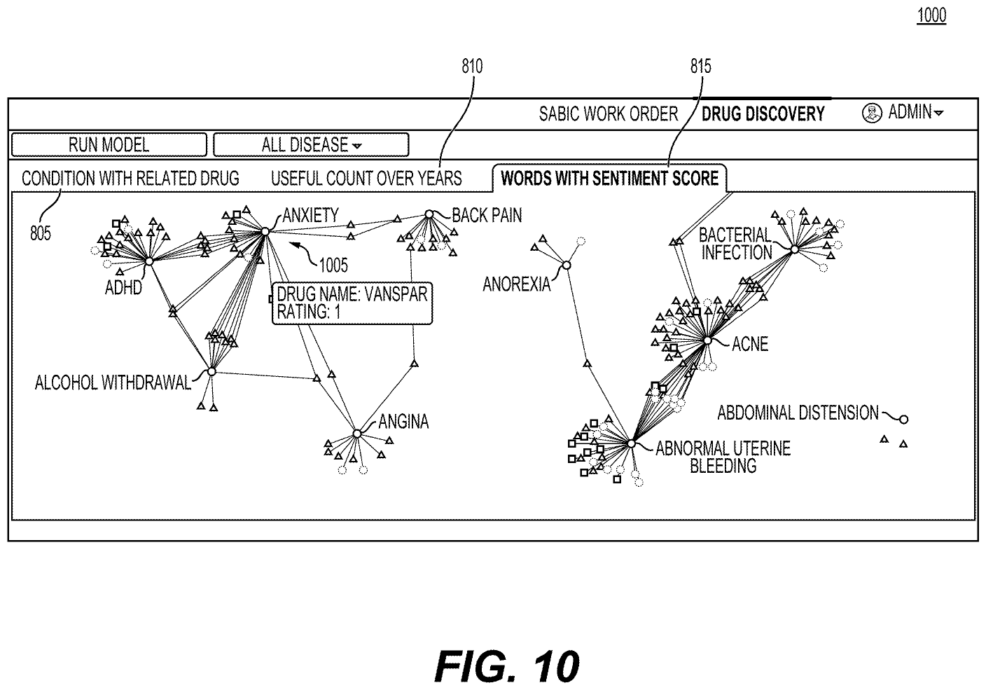

Turning now to FIG. 10, upon selection of another analysis option, such as option 815, which corresponds to “Words with Sentiment Score”, a new cluster graph may be constructed that correlates each condition with the terms in a patient's review used to describe their experience with a drug that targets the condition. For instance, examination of the data subset 1005 corresponding to the condition “anxiety” reveals that an overwhelming number of positive terms were used to describe a patient's experience with Vanspar, which is the drug that was prescribed to treat anxiety.

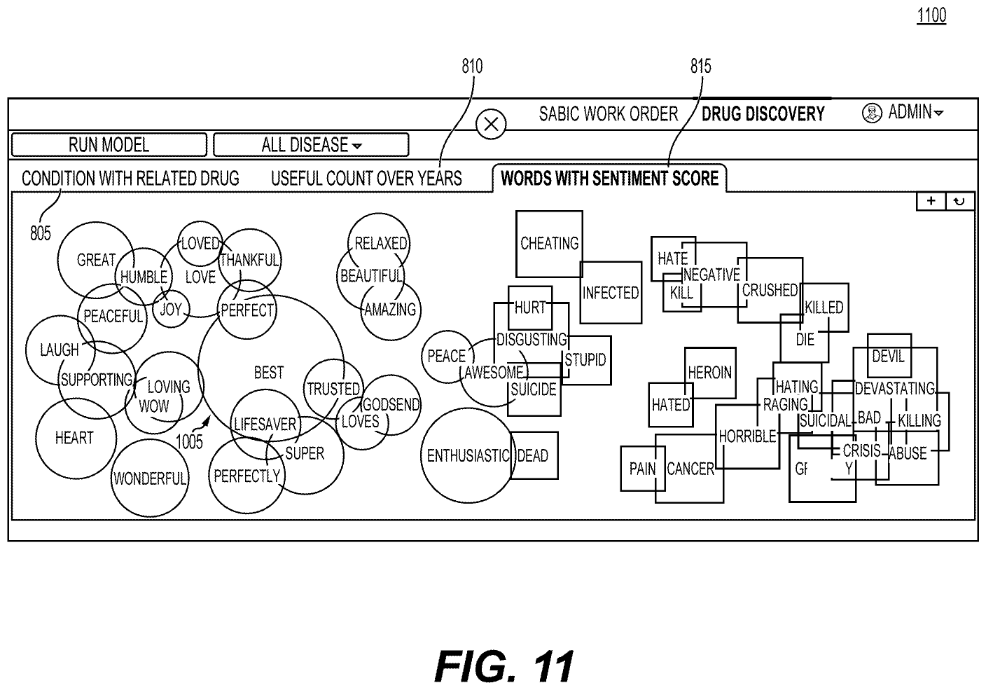

Turning now to FIG. 11, the server system 115 may represent the data presented in FIG. 10 in a different way. More particularly, a user may desire to view a word visualization graph that may identify the types of words associated with positive and negative patient reviews. Positive-based words (e.g., best, wonderful, perfect, etc.) may be surrounded by a circle whereas negative-based words (e.g., hate, pain, kill, etc.) may be surrounded by a square. In an embodiment, the size of the circle or square surrounding each word may indicate the volume of usage in a dataset. For instance, the positive word “best” 1005 may have a larger circle surrounding it, thereby indicating that it was often used in many positive reviews.

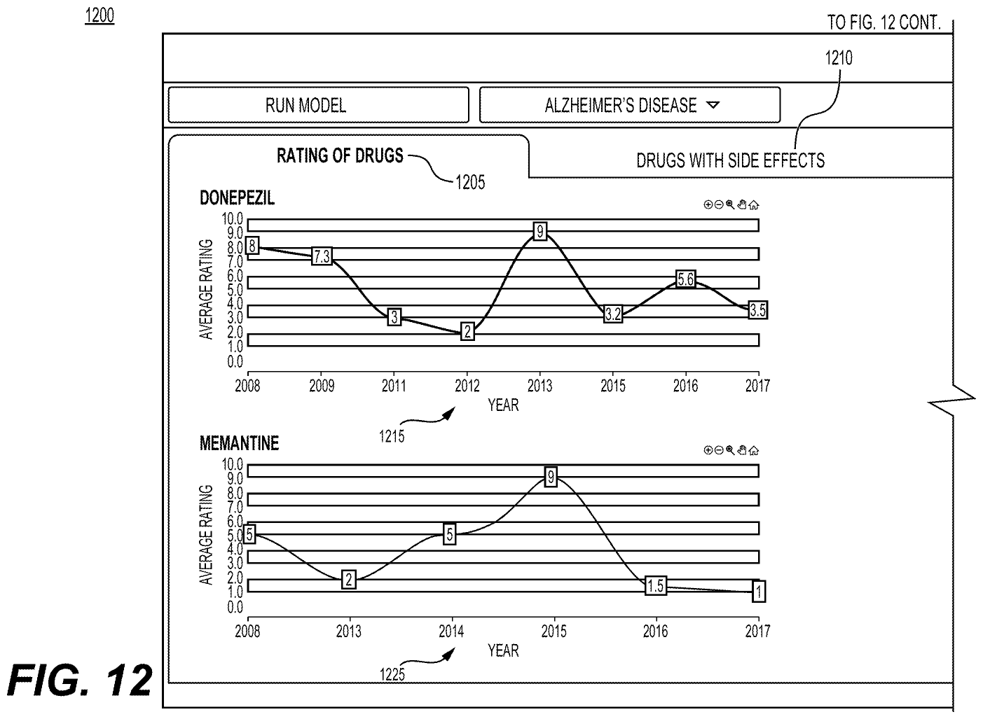

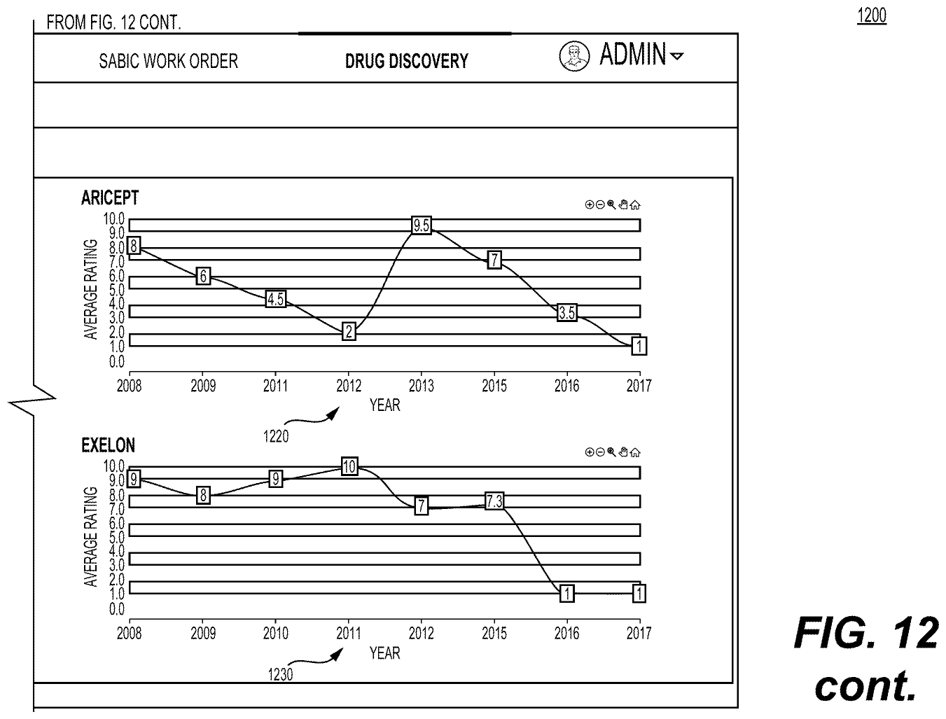

Turning now to FIG. 12, a user may interact with the application platform to obtain additional information about particular drugs. For instance, the application platform may contain options 1205 and 1210 that the user may interact with. Upon selection of option 1205, corresponding to “Rating of Drugs”, the server system 115 may provide a plurality of rating graphs 1215-1230 that illustrate the fluctuation in patient ratings of different drugs over a designated period of time. Each rating value in a graph may represent the aggregated ratings from patient reviews accumulated over a period of time (e.g., a year, etc.). These ratings may provide valuable insights into how well particular drugs are performing and how these drugs are perceived by the consuming population. For instance, graph 1215 depicts a history of patient ratings towards the drug Donepezil over a period of nine years. As can be seen from the graph 1215, the popularity of the drug amongst patients has varied over the years. In an embodiment, the server system 115 may make dynamic suggestions based on the data found in these graphs (e.g., drugs that have accumulated low ratings over multiple consecutive years may be recommended to be discontinued, etc.).

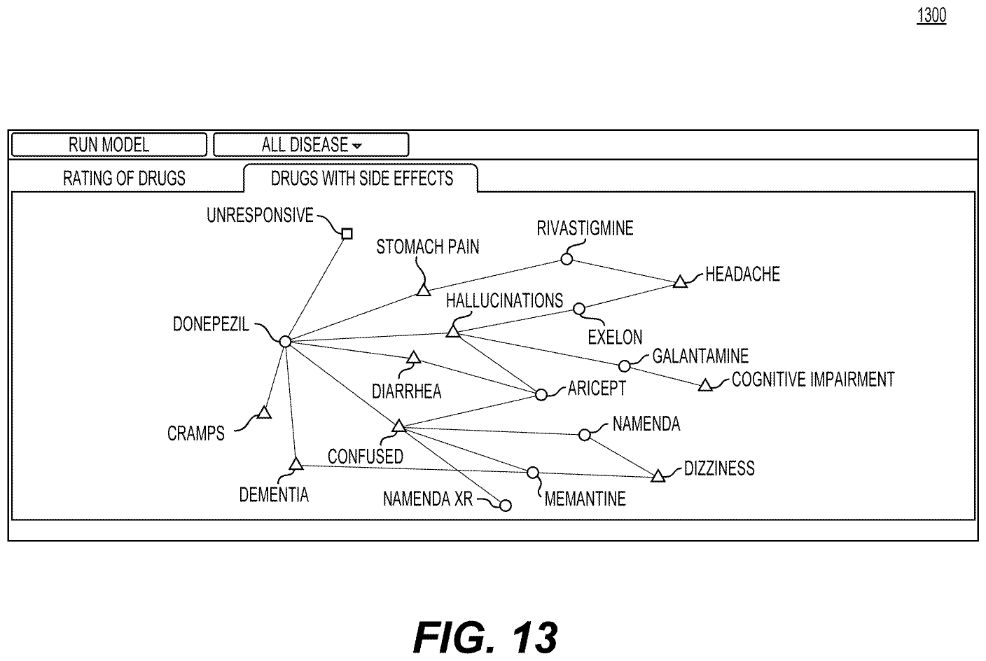

Turning now to FIG. 13, upon selection of option 1210, which corresponds to “Drugs with Side Effects”, the server system 115 may provide a plot graph 1300 that provides indications of the side effects associated with different drugs. More particularly, the plot graph may include a variety of different drugs (e.g., Donepezil, Rivastigmne, Galantamine, etc.) offered by an entity, the known side effects associated with each drug (e.g., stomach pain, hallucinations, diarrhea, confusion, dementia, and cramps are side effects known to be associated with Donepezil), the shared side effects between different drugs (e.g., hallucinations are a shared side effect between Donepezil and Galantamine), and the unknown side effects identified via analysis of the patient reviews as described herein (e.g., unresponsiveness is an unknown side effect of Donepezil revealed from analysis of patient reviews). The plot graph may contain visually distinguishing features (e.g., distinguishing colors, shapes, a combination thereof, etc.) that enable a user to distinguish the information in the graph. For instance, each drug may be represented by a circle, the known side effects may be represented by triangles, and the unknown side effects may be represented by squares.

In a third use case, a dataset comprised of industrial work orders may be received, e.g., at a data acquisition module 120A. The work orders may consist of requests to maintain or fix various different types of industrial assets (e.g., machines, components, etc.) that are located in a particular geographic location, area of an organization, and/or that are incorporated into a larger product. In an embodiment, after elementary data cleaning is performed (e.g., via data validation module 1208 and/or data pre-processing module 120C), a restructured dataset may be obtained that contains textual and/or numerical data for each work order that identifies: the nature of the work order, the asset that was serviced, the date the asset was serviced, the location where the asset was serviced, the index number of the order, and/or other metrics not explicitly listed or described herein.

Upon further processing, e.g., conducted by statistical data processing module 120D and/or analytics engine 120E, insightful data may be gleaned. For instance, the frequency with which an asset or asset type requires maintenance, the maintenance intervals for an asset or asset type, the locations containing a large volume of assets or asset types requiring maintenance, and the like. In an embodiment, the server system 115 may provide dynamic suggestions or recommendations to an entity based upon this knowledge (e.g., to automatically schedule preventative maintenance on assets known to periodically fail, to look for alternative assets to replace existing assets that fail frequently, to pre-emptively allocate additional financial resources to areas those locations where assets are known to require more frequent maintenance, etc.).

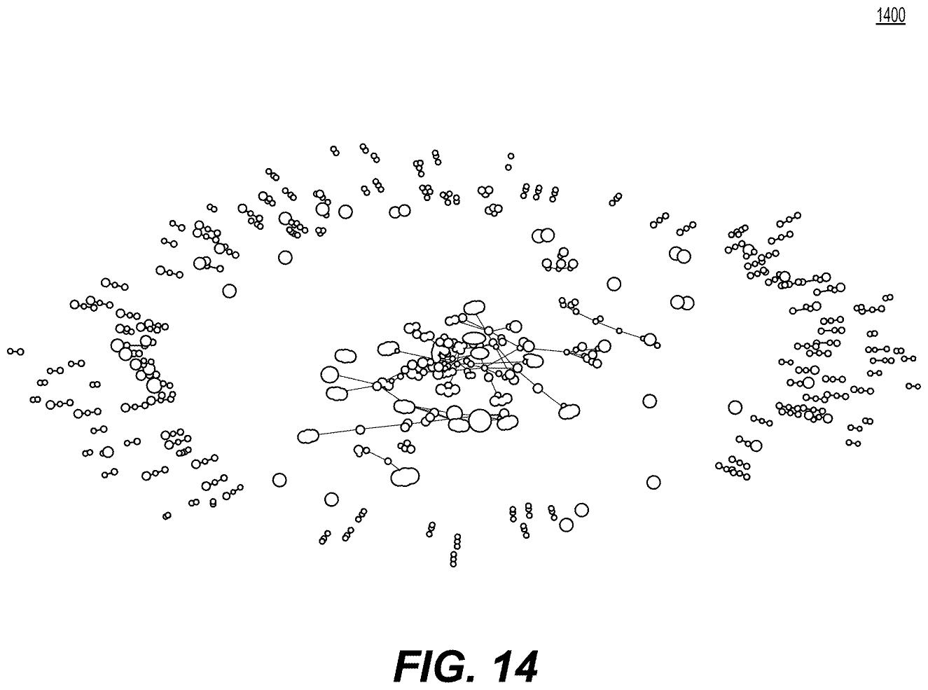

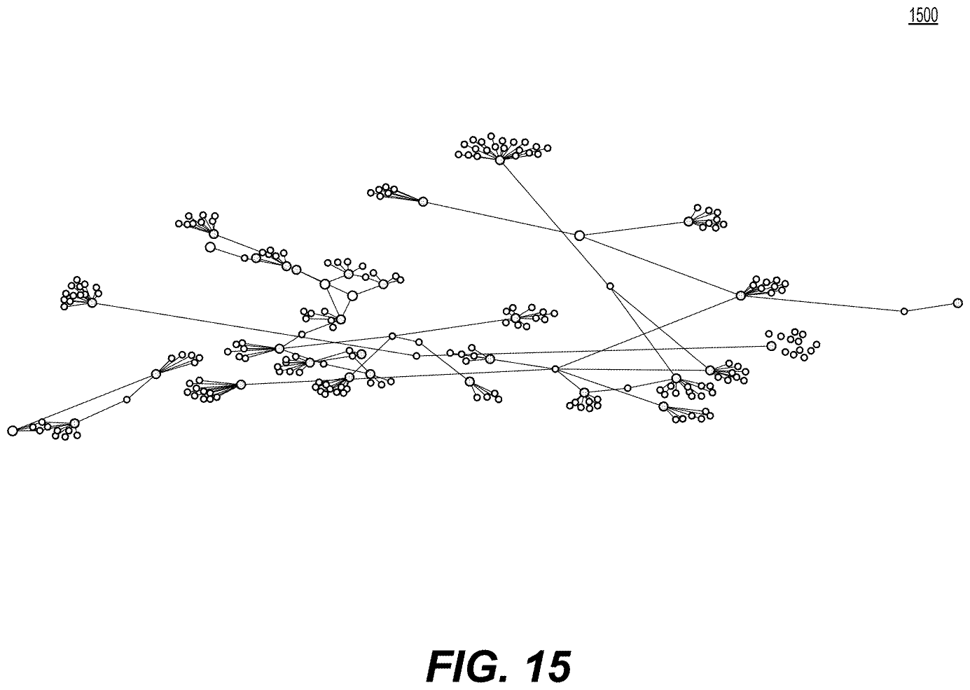

Turning now to FIG. 14, the server system 115 may provide a cluster graph 1400 that provides a representation of work orders and locations. Although represented in black and white for the purposes of this application, the clusters in the graph 1400 may be color-coded, wherein each color is indicative of a location. A more granular examination of the data contained in FIG. 14 may be found in the cluster graph 1500 of FIG. 15, which illustrates the inter-relationships between locations and work order histories. Each filled circle with dots may represent a location and each empty circle represent a work order placed for that location. In an embodiment, massive interlinking denotes shared location and/or shared work order.

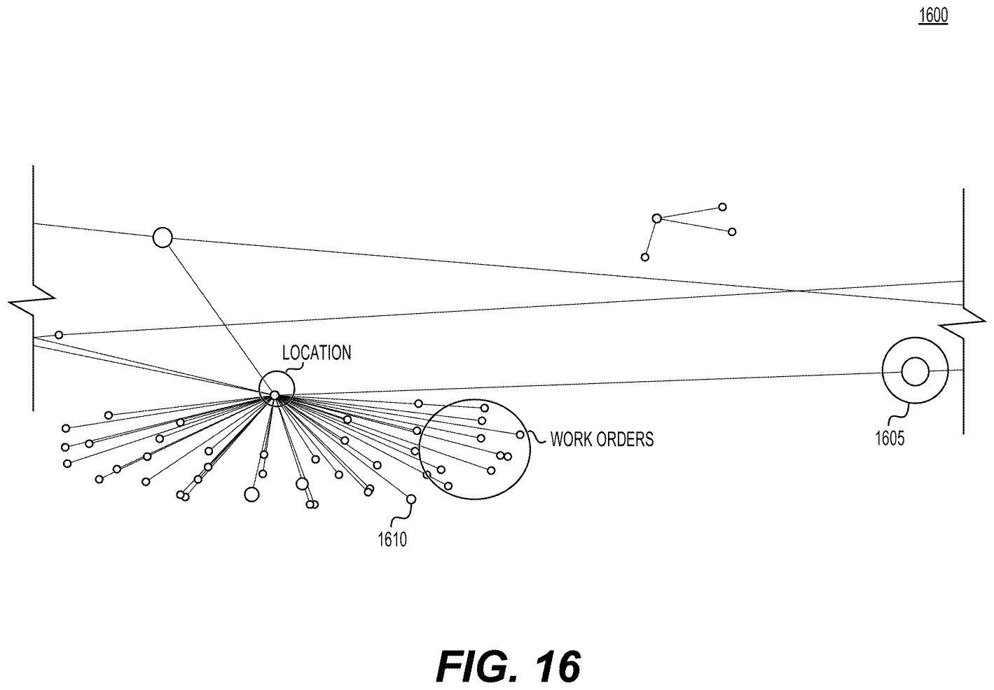

Turning now to FIG. 16, the server system 115 may provide a cluster graph 1600 that provides an even more granular view of the cluster graphs illustrated in FIGS. 14 and 15. More particularly, the cluster graph 1600 may identify a central node (i.e., filled with dots) that denotes a location where a work order originates or is requested to occur and a plurality of leaf nodes that identify the different types of work orders associated with that location. In an embodiment, the size of the leaf nodes may be representative of the frequency of occurrences of the same or similar work order. For example, a leaf node 1605 associated with a maintenance request for an offline belt conveyer may be much larger than another leaf node 1610 associated with a maintenance request for a robotics component, thereby indicating that more work orders have been received for the offline belt conveyer than the robotics component. As previously mentioned, the server system 115 may leverage this knowledge to perform various actions (e.g., to dynamically suggest an overhaul or replacement of the offline belt conveyer when a predetermined number of work orders have been received in total or within a predetermined period of time, etc.).

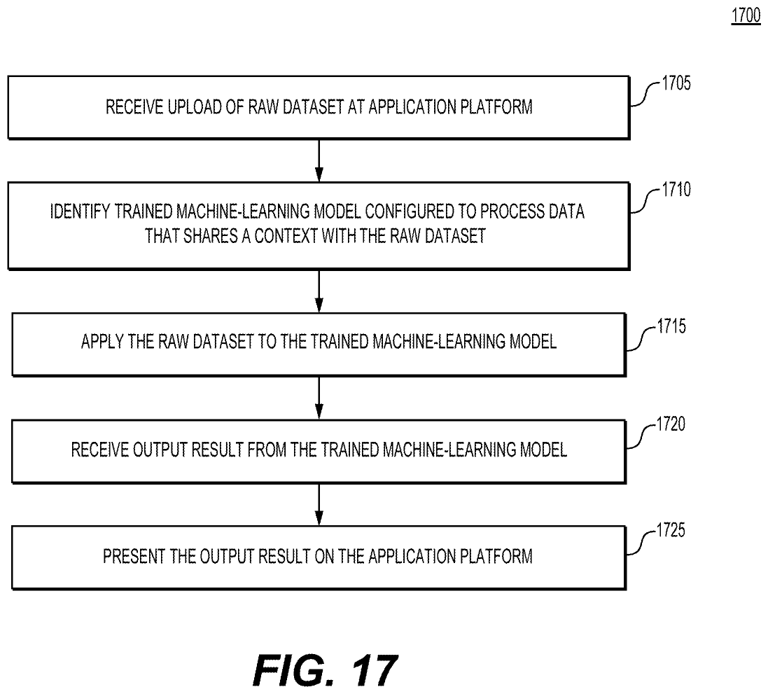

Turning now to FIG. 17, a flowchart illustrating an exemplary method 1700 for providing informative output from extracted features of a raw dataset is provided, according to one or more embodiments of the present disclosure. The method 1700 may be performed by one or more of the components of the exemplary environment 100 illustrated in FIG. 1.

At step 1705, a raw dataset may be received at an application platform associated with a server system 115. The raw dataset may include data associated with virtually any industry or field (e.g., construction, medicine, customer service, etc.). The types of data included in the raw dataset may be dependent upon the industry or field that is associated with the dataset (e.g., work order requests for an industry-related dataset, drug side effect reports for a medical-related dataset, customer satisfaction reports for a service-related dataset, etc.). The dataset may be uploaded to the application platform by a user via interaction with a user interface of the application platform.

At step 1710, the server system 115 may identify a trained machine-leaning model that is configured/trained to process data that shares a context associated with the uploaded raw dataset. The identification may be facilitated by user selection of a trained machine-learning model from a plurality of trained machine-learning models. For instance, the application platform may present to the user a plurality of trained machine-learning models that they can select from, wherein each of these models is associated with a particular context. More particularly, each of the models may be configured and optimized to process data types associated with a particular industry or field. In another embodiment, the identification may be facilitated dynamically by the server system 115. For example, the server system 115 may perform an analysis on some or all of the data in the raw dataset (e.g., by initiating a word analysis protocol, etc.) to determine a context associated with the raw dataset. Once this context is determined, the server system 115 may suggest or assign a trained machine-leaning model that matches the determined context of the raw dataset.

At step 1715, the raw dataset may be applied to the trained machine-leaning model and, at step 1720, an output result may be received from the trained machine-leaning model. This output result may subsequently be presented, at step 1725, to the user on the application platform. In an embodiment, the output result may include a graph (e.g., a cluster graph, a choropleth graph, a bar graph, a line graph, etc.) that illustrates a relationship between elements contained in the raw dataset. Additionally or alternatively to the foregoing, the output result may contain a suggestion to adjust one or more activities of an organization (e.g., to devote additional resources to a particular geographic location or individual, to make changes in employee personnel, to increase or decrease marketing for a particular product, etc.).

In general, any process discussed in this disclosure that is understood to be performable by a computer may be performed by one or more processors. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. In some embodiments, a cluster of computing systems each having one or more processors may be configured to perform any process as discussed in this disclosure in a parallelized manner. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for providing informative output from extracted features of a raw dataset, the method comprising:
receiving, at an application platform associated with a computer system, an upload of the raw dataset;
identifying, using a processor associated with the computer system, a trained machine-learning model configured to process data that shares a context associated with the raw dataset;
applying, using the processor, the raw dataset to the trained machine-learning model;
receiving, from the trained machine-learning model, an output result; and
presenting, subsequent to the receiving, the output result on the application platform.

2. The computer-implemented method of claim 1, wherein identifying the trained machine-learning model comprises receiving, from a user, a selection on the trained machine-learning model from a plurality of trained machine-learning models, wherein each of the plurality of trained machine-learning models is associated with a unique context.

3. The computer-implemented method of claim 1, wherein identifying the trained machine-learning model comprises:
deriving, upon an analysis of words contained in the raw dataset using the processor, the context associated with the raw dataset; and
automatically selecting, based on the deriving, the trained machine-learning model.

4. The computer-implemented method of claim 1, further comprising:
presenting, prior to application of the raw dataset to the identified trained machine-learning model, a template on the application platform;
receiving, from a user, one or more contextual parameter designations for the raw dataset; and
applying, in conjunction with the raw dataset, the one or more contextual parameter designations to the trained machine-learning model.

5. The computer-implemented method of claim 1, wherein the output result is a graph illustrating a relationship between elements contained in the raw dataset.

6. The computer-implemented method of claim 5, wherein the graph is one of: a cluster graph, a choropleth graph, a bar graph, and a line graph.

7. The computer-implemented method of claim 1, wherein the output result corresponds to a suggestion to adjust one or more activities of an organization that produces the raw dataset to improve an efficiency of the organization.

8. A system for providing informative output from extracted features of a raw dataset, comprising:
at least one database;
a processor;
a server in network communication with the at least one database; the server configured to perform operations including:
receiving, at an application platform associated with the computer system, an upload of the raw dataset;
identifying, using the processor, a trained machine-learning model configured to process data that shares a context associated with the raw dataset;
applying, using the processor, the raw dataset to the trained machine-learning model;
receiving, from the trained machine-learning model, an output result; and
presenting, subsequent to the receiving, the output result on the application platform.

9. The system of claim 8, wherein identifying the trained machine-learning model comprises receiving, from a user, a selection on the trained machine-learning model from a plurality of trained machine-learning models, wherein each of the plurality of trained machine-learning models is associated with a unique context.

10. The system of claim 8, wherein identifying the trained machine-learning model comprises:
deriving, upon an analysis of words contained in the raw dataset using the processor, the context associated with the raw dataset; and
automatically selecting, based on the deriving, the trained machine-learning model.

11. The system of claim 8, wherein identifying the trained machine-learning model comprises receiving, from a user, a selection on the trained machine-learning model from a plurality of trained machine-learning models, wherein each of the plurality of trained machine-learning models is associated with a unique context.

12. The system of claim 8, wherein identifying the trained machine-learning model comprises:
deriving, upon an analysis of words contained in the raw dataset using the processor, the context associated with the raw dataset; and
automatically selecting, based on the deriving, the trained machine-learning model.

13. The system of claim 8, further comprising:
presenting, prior to application of the raw dataset to the identified trained machine-learning model, a template on the application platform;
receiving, from a user, one or more contextual parameter designations for the raw dataset; and
applying, in conjunction with the raw dataset, the one or more contextual parameter designations to the trained machine-learning model.

14. The system of claim 8, wherein the output result is a graph illustrating a relationship between elements contained in the raw dataset.

15. The system of claim 14, wherein the graph is one of: a cluster graph, a choropleth graph, a bar graph, and a line graph.

16. The system of claim 8, wherein the output result corresponds to a suggestion to adjust one or more activities of an organization that produces the raw dataset to improve an efficiency of the organization.

17. A non-transitory computer-readable medium storing computer-executable instructions which, when executed by a server in network communication with at least one database, cause the server to perform operations comprising:
receiving, at an application platform associated with a computer system, an upload of the raw dataset;
identifying, using a processor associated with the computer system, a trained machine-learning model configured to process data that shares a context associated with the raw dataset;
applying, using the processor, the raw dataset to the trained machine-learning model;
receiving, from the trained machine-learning model, an output result; and
presenting, subsequent to the receiving, the output result on the application platform.

18. The non-transitory computer-readable medium of claim 17, wherein the identifying the trained machine-learning model comprises:
deriving, upon an analysis of words contained in the raw dataset using the processor, the context associated with the raw dataset; and
automatically selecting, based on the deriving, the trained machine-learning model.

19. The non-transitory computer-readable medium of claim 17, further comprising:
presenting, prior to application of the raw dataset to the identified trained machine-learning model, a template on the application platform;
receiving, from a user, one or more contextual parameter designations for the raw dataset; and
applying, in conjunction with the raw dataset, the one or more contextual parameter designations to the trained machine-learning model.

20. The non-transitory computer-readable medium of claim 17, wherein the output result corresponds to a suggestion to adjust one or more activities of an organization that produces the raw dataset to improve an efficiency of the organization.
